(19) United States
(12) Patent Application Publication
(10) Pub. No.: US 2024/0199187 A1
(43) Pub. Date: Jun. 20, 2024

(54) SYSTEM AND DEVICES FOR HIGH ALTITIDUE ATMOSPHERIC PAYLOAD TRANSPORTATION AND DEPLOYMENT

(71) Applicant: Thomas Compton James, Northamptonshire (GB)

(72) Inventors: Sohrab Haghighat, Concord (CA); Anirudh Ajay Agarwal, Concord (CA); Andreas Olivier Robbins MARQUIS, Concord (CA); Jonathan Lee Vivian Lesage, Concord (CA); Ken Lee, Concord (CA); Manel Ajbouni, Concord (CA); Charles Alexander Mader, Concord (CA); David Lewis Platt, Concord (CA)

(21) Appl. No.: 18/267,396

(22) PCT Filed: Dec. 13, 2021
(86) PCT No.: PCT/US21/63168

§ 371 Date: Nov. 7, 2023

Related U.S. Application Data
(60) Provisional application No. 63/125,018, filed on Dec. 14, 2020.

(51) Int. Cl. B64B 1/08; B64B 1/00; B64B 1/30; B64D 1/12; B64D 5/00

(52) U.S. Cl. CPC B64B 1/08; B64B 1/005; B64D 1/12; B64B 1/30; B64D 5/00

(57) ABSTRACT

Systems, methods and device for payload transportation and high altitude atmospheric payload deployment. A gondola includes a frame which is configured to carry a payload, such as a rocket. The gondola includes a control system using a plurality of propellers to provide orientation changes. In the instance of a carried rocket, the system provides timed release such that the rocket is released in desired direction and pitch angle.

### CROSS-REFERENCE TO RELATED APPLICATIONS

This application claims the benefit of U.S. Provisional Application Ser. No. 63/125,018 filed on Dec. 14, 2020, which is hereby incorporated by reference in its entirety.

### FIELD

The present disclosure relates generally to high altitude atmospheric payload transportation and deployment, and in particular to a system, method and devices for high altitude atmospheric rocket transportation, deployment and launch.

### BACKGROUND

Space flight and exploration is a time- and resource-intensive endeavor. The launch of equipment associated with space flight and exploration has a number of constraints in terms of cost, availability and complexity.

Typically, to launch satellite into space, a rocket or space shuttle carries the satellite as payload or cargo, and send into the thermosphere about 85-640 kms or 50-400 miles above Earth's surface, or higher. These rockets and space shuttles are limited in availability, and involve a high capital cost.

Rockets are typically launched from the ground. Ground launch is not very efficient and requires infrastructure. Air launch approaches from airplanes also exist, but this is expensive due to the high capital and maintenance cost of airplane. Stratospheric balloons can be an alternative in some situations.

Improvements in approaches to high altitude atmospheric rocket launch are desirable.

### SUMMARY

Systems, methods and device for payload transportation and high altitude atmospheric payload deployment are described herein. In one embodiment, a gondola includes a frame which is configured to carry a payload, such as a rocket. The gondola includes a control system using a plurality of propellers to provide orientation changes. In the instance of a carried rocket, the system provides timed release such that the rocket is released in desired direction and pitch angle.

In an embodiment, the present disclosure provides a stratospheric gondola configured to carry an orbital rocket to a high altitude atmosphere, comprising: a frame configured to carry an orbital rocket and a payload of the orbital rocket; a plurality of legs connected to the frame; and a control system connected to the frame, the control system comprising a plurality of propellers, one or more sensors, and two or more releasable attachment units, configured to orient the stratospheric gondola to point the gondola in a desired direction, release the carried orbital rocket, and initiate its launch sequence.

In an example embodiment, the plurality of propellers comprises a first primary propeller configured to move the gondola in a first direction, and a second primary propeller configured to move the gondola in a second direction opposite the first direction.

In an example embodiment, the plurality of propellers comprises a first redundant propeller configured to move the gondola in the first direction, and a second redundant propeller configured to move the gondola in the second direction.

In an example embodiment, one or more of the legs is configured to be provided in an operational position or in a stowed position.

In an example embodiment, one or more of the legs is configured to be removable.

In an example embodiment, at least one of the plurality of legs is configured to be collapsible.

In an example embodiment, each of the plurality of legs is configured to be removable for transportation.

In an example embodiment, the removable legs are configured to separate from the main gondola frame through a series of shear pins.

In an example embodiment, the plurality of legs comprises at least 3 legs. In an example embodiment, the plurality of legs comprises 4 legs.

In an example embodiment, the gondola further comprises an energy absorbing material configured to absorb energy during landing, and reduce stress on the gondola.

In an example embodiment, the energy absorbing material comprises a crushable material provided in an impact-bearing component of the gondola.

In an example embodiment, the energy absorbing material comprises a spring-damper provided in an impact-bearing component of the gondola.

In an example embodiment, the energy absorbing material is provided at one or more of the plurality of legs.

In an example embodiment, at least one of the plurality of legs comprises a telescopic leg, and wherein the energy absorbing material is provided within the telescopic leg.

In an example embodiment, each plurality of legs comprises a telescopic leg, and wherein the energy absorbing material is provided within each of the telescopic legs.

In another embodiment, the present disclosure provides an active payload transportation device configured to carry and launch an active payload in a high altitude atmosphere, comprising: a frame configured to carry the active payload; a plurality of legs connected to the frame; and a control system connected to the frame, the control system comprising a plurality of propellers configured to orient the device to point the active payload in a direction of orbit for launching the active payload.

In a further embodiment, the present disclosure provides a payload transportation device configured to carry and orient an operable payload in a high altitude atmosphere, comprising: a frame configured to carry the operable payload; a plurality of legs connected to the frame; and a control system connected to the frame, the control system comprising a plurality of propellers configured to orient the device to point the operable payload in a desired direction of orientation for operation of the operable payload.

In an example embodiment, the operable payload comprises a scientific payload. In an example embodiment, the scientific payload comprises a telescope.

### BRIEF DESCRIPTION OF THE DRAWINGS

Embodiments of the present disclosure will now be described, by way of example only, with reference to the attached Figures.

FIG. 1A illustrates a system for active payload transportation, including a stratospheric gondola according to an embodiment of the present disclosure.

FIG. 1B illustrates a system for active payload transportation, including a stratospheric gondola according to an embodiment of the present disclosure.

FIG. 2A is a block diagram illustrating an active payload transportation device, such as a stratospheric gondola, according to an embodiment of the present disclosure.

FIG. 2B is a flow chart illustrating an exemplary method that may be performed in accordance with some embodiments of the present disclosure.

FIG. 2C is a flow chart illustrating an exemplary method that may be performed in accordance with some embodiments of the present disclosure.

FIG. 3A illustrates an example embodiment of an active payload transportation device comprising a gondola in a first position.

FIG. 3B illustrates an example embodiment of an active payload transportation device comprising a gondola in a first position.

FIG. 4A illustrates the gondola of FIG. 3A in a second position.

FIG. 4B illustrates the gondola of FIG. 3B in a second position.

FIG. 5A illustrates details of a gondola frame according to an embodiment of the present disclosure.

FIG. 5B illustrates details of a gondola frame according to an embodiment of the present disclosure.

FIG. 6A illustrates details of gondola legs according to an embodiment of the present disclosure.

FIG. 6B illustrates details of gondola legs according to an embodiment of the present disclosure.

FIG. 6C illustrates details of gondola legs according to an embodiment of the present disclosure.

FIG. 7A illustrates details of a gondola control system according to an embodiment of the present disclosure.

FIG. 7B illustrates details of a gondola control system according to an embodiment of the present disclosure.

FIG. 8 is a diagram illustrating an exemplary computer/control system that may perform processing in some embodiments and in accordance with aspects of the present disclosure.

FIG. 9 is a diagram illustrating an exemplary computer/control system that may perform processing in some embodiments and in accordance with aspects of the present disclosure.

### DETAILED DESCRIPTION

A device, for example a stratospheric gondola, is provided to carry and deploy a payload (such as an orbital rocket) in a high altitude atmosphere. The device includes: a frame configured to carry the orbital rocket and a payload of the orbital rocket, for example one or more satellites; a plurality of legs connected to the frame; and a control system connected to the frame. The control system includes a plurality of propellers configured to orient the device to point the payload in a direction of orbit for launching the payload. The plurality of propellers may include a first pair of primary and redundant propellers configured to move the gondola in a first direction, and a second pair of primary and redundant propellers configured to move the gondola in a second direction opposite the first direction. One or more of the legs may be a removable and/or telescopic leg, with energy absorbing material being provided within the telescopic leg.

For the purpose of promoting an understanding of the principles of the disclosure, reference will now be made to the features illustrated in the drawings and specific language will be used to describe the same. It will nevertheless be understood that no limitation of the scope of the disclosure is thereby intended. Any alterations and further modifications, and any further applications of the principles of the disclosure as described herein are contemplated as would normally occur to one skilled in the art to which the disclosure relates. It will be apparent to those skilled in the relevant art that some features that are not relevant to the present disclosure may not be shown in the drawings for the sake of clarity.

At the outset, for ease of reference, certain terms used in this application and their meaning as used in this context are set forth below. To the extent a term used herein is not defined below, it should be given the broadest definition persons in the pertinent art have given that term as reflected in at least one printed publication or issued patent. Further, the present processes are not limited by the usage of the terms shown below, as all equivalents, synonyms, new developments and terms or processes that serve the same or a similar purpose are considered to be within the scope of the present disclosure.

An active payload comprises a rocket, a scientific payload, and/or a satellite that will be sent to space.

In an embodiment, the present disclosure provides a system, such as a gondola, configured to carry a rocket into the atmosphere, for example to a high altitude atmosphere (30+km) and provide a stable, controllable platform for the launch of that rocket. In an example embodiment, the system includes a lightweight structure to support all the elements (frame), an avionics system to provide the navigation and control capabilities, a swiveling lifting system to connect the gondola to a balloon, helicopter or other lifting vehicle (hoisting system), a launch mechanism to release and ignite the rocket, and a landing system. The system according to an embodiment of the present disclosure is configured to ascend to a target altitude while attached to a balloon, point and launch the rocket, separate from the balloon and return to the ground via a parachute.

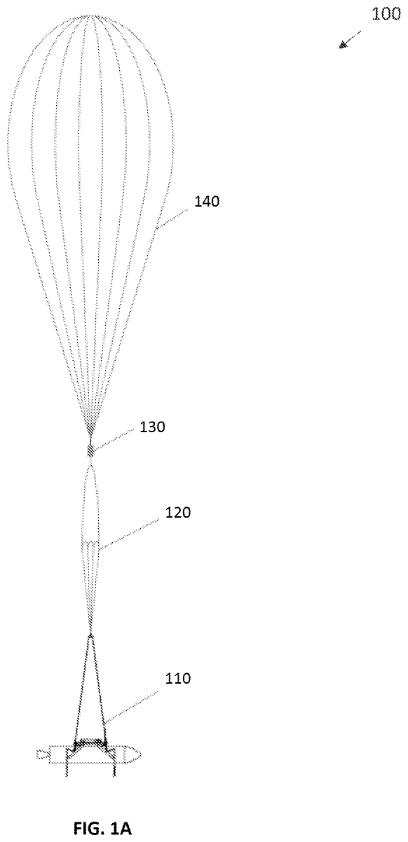

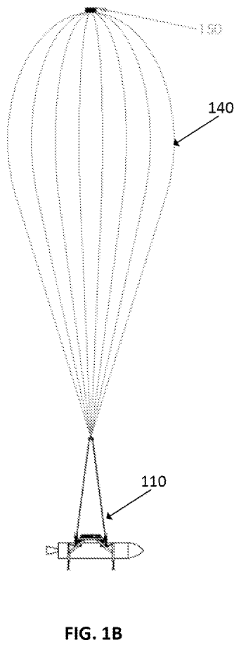

FIG. 1A illustrates a system for active payload transportation, including a stratospheric gondola according to an embodiment of the present disclosure. The system 100 includes a gondola 110, a parachute 120, a separation mechanism 130 and a balloon 140. In example embodiments, element 110 can be provided as a payload carrier, or an active payload transportation device. In an example embodiment, the gondola is a stratospheric gondola. The gondola 110 may be configured to carry a rocket, which the rocket itself may carry one or more payloads into the Earth's atmosphere, for example into the stratosphere, for placement into space after being launched from the gondola. In an example embodiment, the rocket's payload is a satellite to be launched into orbit. The payload (e.g., rocket) may be hoisted up by a hoisting system, which in this example includes a balloon 140. Other examples of a hoisting system include a helicopter or another lifting vehicle.

In an example implementation, first the rocket is launched or, if the payload is anything other than rocket, the mission will be performed; then, once the mission is over, the separation mechanism will activate. The separation mechanism 130 is engaged to separate the balloon 140 from the parachute 120 and gondola 110. The parachute 120 is used to permit the gondola 110 to land safely on the Earth such that the gondola 110 can be re-used. In an example embodiment using a helicopter or a hot air balloon, or another lifting vehicle that can perform a controlled descent, the separation system and the parachute are not needed, and may therefore be considered as optional in some embodiments and implementations. The separation mechanism may have a wireless communication system and/or controller to receive a command to cause the separation of the balloon 140 and/or the parachute 120 from one another.

A system 100 according to an embodiment of the present disclosure is configured to carry a rocket into the Earth's high atmosphere in order to fire the rocket and launch the rocket's payload, for example a satellite, into orbit. This is in contrast to known balloon gondola approaches, which were not concerned with putting an object into orbit, or with the associated factors relating to position and orientation. The gondola 110 is configured for recovery and reusability. In another embodiment, the gondola 110 is provided as a more general active payload transportation device 110, and is configured to carry a wide range of payloads, whether the payload needs to be launched into a precise orbit, or whether the payload is a type of scientific payload.

FIG. 1B illustrates a system for active payload transportation, including a stratospheric gondola according to an embodiment of the present disclosure. The system 100 includes a gondola 110, a balloon 140 and a balloon valve 150.

Gondola 110 and balloon 140 may be the same or similar to that as described with regard to FIG. 1A above. In some embodiments, first, the rocket is launched or, if the payload is anything other than rocket, the mission will be performed; then, once the mission is over, the balloon valve 150 may be modulated to release, in a controlled manner, lifting gas from the balloon 140. The modulation of the balloon valve 150, and therefore the amount of lifting gas released, may be based upon sensor readings, altitude, position (GPS coordinates of the system 100), wind speed, weather maps/simulations, radar or combination thereof. In some embodiments, a modulation profile may be used to facilitate a predetermined descent plan. In some embodiments, the modulation may be determined in real-time based on any data available to the system 100 at the time of descent. In some embodiments, the balloon valve 150 may be positioned at the top of balloon 140 as shown in FIG. 1B. In some embodiments, a plurality of balloon valves may be positioned at different positions on the balloon 140 and modulated independently from one another. In some embodiments, some or all of the balloon valves may be controlled together in a linked manner.

In some embodiments, the balloon valve 150 may be configured to release a first amount of lifting gas, in order to reduce the altitude of the system 100 to a desired altitude. Once at the desired altitude, the system 100 be configured to wait until a favorable wind is present before beginning any additional release. In some embodiments, the system 100 may perform altitude adjustments by way of the balloon valve 150, to maneuver the system towards a landing zone. The maneuvering may be accomplished by changing altitude and loiter time at said altitude based on wind speed and direction and predicted and/or air currents/streams.

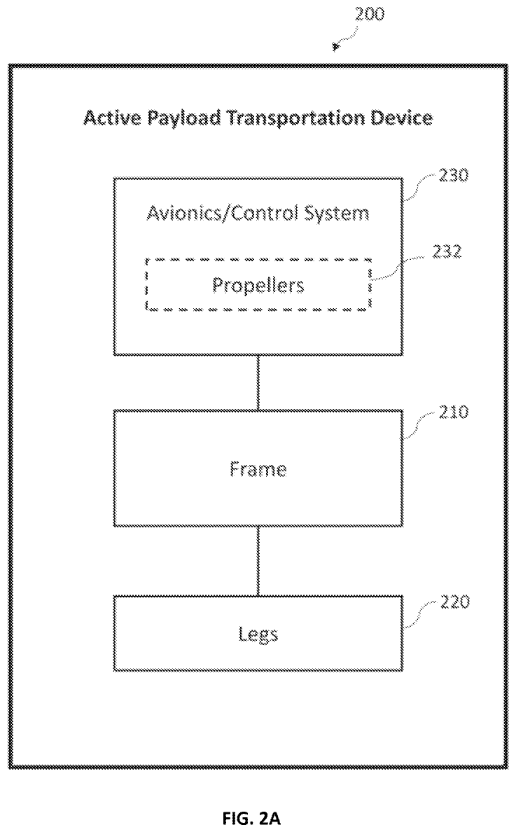

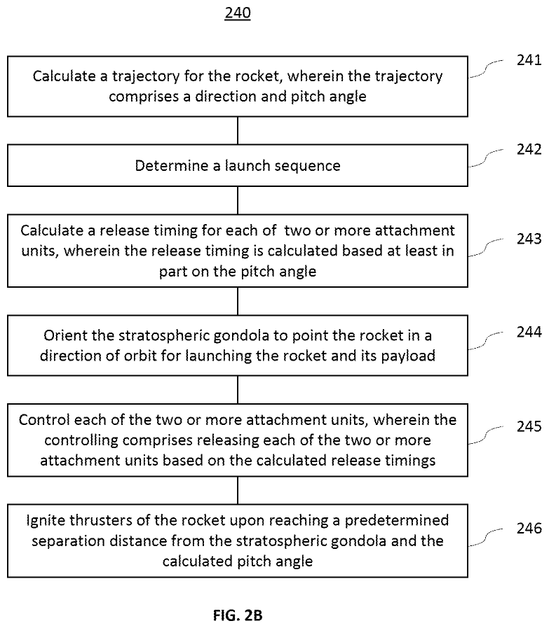

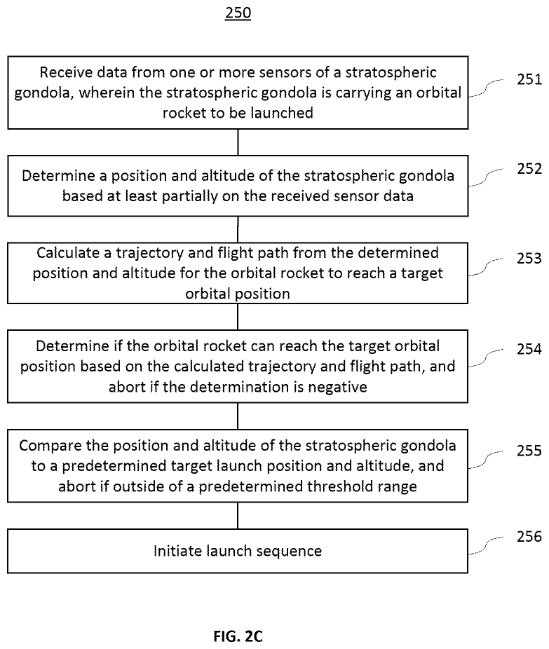

FIG. 2A is a block diagram illustrating an active payload transportation device 200, such as a stratospheric gondola, according to an embodiment of the present disclosure. The device 200 comprises a frame 210, legs 220 connected to the frame, and an avionics/control system 230 also connected to the frame. In an embodiment, the device 200 is a gondola configured to carry an orbital rocket. The frame 210 is configured such that it can lift, hold and attach the rocket, which itself carries a payload. The frame 210 and the avionics/control system 230 are configured to cooperate to launch the payload (such as a rocket), for example by releasing and launching the payload mid-air.

In some embodiments, the avionics/control system 230 may be configured to sequence the launch of a rocket. The sequencing of the launch may comprise calculating the path that the rocket has to take to reach its target orbit. In some embodiments, one or more algorithms may be used in the determining of the launch sequence and the calculating of the flight path. Simulations performed before and/or during the launch sequence may be used in the calculating of the flight path and the execution of the launch sequence. In some embodiments, simulations and calculations may be performed both by the avionics/control system 230 and systems external to the payload transport device 200 (i.e., cloud platforms, servers, command/flight control centers). In some embodiments, weather models as well as real-time weather readings, from environmental sensors, may be used to calculate the flight path and launch sequence. For example, based on the current position and orientation of the gondola device 200, as well as current wind and environmental readings, a current trajectory, an ideal trajectory, a launch angle, release timing and release sequence may be calculated. The propellers may then be controlled by the avionics/control system 230 to change the direction of the device and the attached rocket, from the current trajectory to the desired trajectory. Once the rocket is pointed in the correct direction, the release mechanisms holding the rocket to the frame may be actuated to launch the rocket. The timing and sequence of the release of each release mechanism may be calculated to provide the rocket with the desired pitch angle (e.g., launch angle) upon release.

In some embodiments, new trajectories may be calculated to compensate for drift caused by wind or other factors. The frequency at which new trajectories are calculated may be based upon the amount of drift detected from the intended launch position or the rate of drift detected. In some embodiments, the avionics/control system 230 may be configured to determine if the amount of drift and/or environmental conditions are such that it is impossible or improbable to successfully reach the desired target position/orbit. If a trajectory cannot be calculated to put the rocket into its intended orbit, the device 200 may abort the mission. In some embodiments, the decision to abort may be based on a probability of success, and a predetermined threshold may be set, below which the mission may be aborted or delayed until a new trajectory with a probability of success is above the predetermined threshold.

In some embodiments, the payload may be attached to the frame 210 at two or more positions. Each of the two or more attachment positions may comprise mechanical structures or mechanisms configured to releasably hold the payload in place. In some embodiments, actuators at each attachment position may be configured to release or otherwise separate the payload from the frame 210. In some embodiments, each of the two or more attachment mechanisms may be controlled independently of one another. The order and timing of each release may be determined based on the desired attitude/orientation of the payload upon release. For example, a rear attachment mechanism may be released before a frontal attachment mechanism to orient the tip of the payload in an upward direction. In some embodiments, when a rocket is the payload, the timing of the release may be configured to bring the rocket into a desired attitude when the rocket has reached a safe ignition distance from the frame. In some embodiments, the attachment mechanisms may be controlled hook based systems, wherein each hook that holds the payload in place may be actuated to facilitate release of the payload.

In an embodiment, an avionics portion of the avionics/control system 230 is configured to perform computation relating to navigation system, communications to the ground, as well as thermal and power management for battery systems. In an embodiment, the avionics/control system 230 is configured to orient or point the payload in a specific direction, which determines the orbit of the rocket. In an embodiment, the avionics/control system 230 comprises an avionics system, and a control system as a subset of the avionics system.

In some embodiments, the payload transportation device 200 may further comprise inertial measurement units (gyroscopes/accelerometers), magnetometers, barometers, altimeters, and/or GPS units. The payload may also house sensor units that are the same or similar to that of the payload transportation device 200. The sensor readings from the payload, the payload transportation device 200 or both may be used in trajectory and launch sequence calculations. The sensors on the payload may also be used to adjust its trajectory in real-time, after separation from the payload transportation device 200. In some embodiments, the payload (rocket) may also, or alternatively, comprise horizon sensors, image sensors (cameras) and/or sun sensors. These sensors may provide additional information with regard to orientation, trajectory and the pitch of the payload.

In an example embodiment, the avionics/control system 230 comprises a plurality of thrusters 232, such as propellers. Example embodiments are described herein wherein the thrusters are propellers. In other example embodiments, the thrusters comprise cold gas thrusters or electric thrusters. Discussions herein relating to embodiments involving the thrusters as propellers also apply to other types of thrusters. The propellers 232 are configured to rotate or orient the device 200 to position the rocket for desired orbit of the payload. In an example embodiment, the propellers 232 comprise a first primary propeller configured to move the device 200 in a first direction, and a second primary propeller configured to move the device 200 in a second direction opposite the first direction. In an example embodiment, the propellers 232 comprise two primary propellers and two redundant propellers. In an example embodiment, the avionics/control system 230 is configured to operate in a launch and release mode, when carrying an orbital rocket and payload to be launched into orbit. In another example embodiment, the avionics/control system 230 is configured to operate in an orientation mode, when carrying a rocket and a scientific payload, such as a telescope, in order to properly point the telescope.

In an example embodiment, the avionics/control system 230 is configured to control the device 200 such that when the rocket is launched, the rocket is pointed in a specific desired direction associated with the path of orbit of the payload. In the case of a scientific payload, such as a telescope, the ability to provide a specific orientation is important to be able to point the telescope, for example in the case of a task of observing a specific star.

In some embodiments, the device 200 and the rocket may be in communication with one another before, during and after separation. Both may use their sensors to determine current heading/trajectory and any deviation or drift from the calculated trajectory. The performing of real-time trajectory calculations on both the device 200 and the rocket may provide redundancy in case of failure of one or more sensors on the device 200 or the rocket. In some embodiments, the sensor readings, and calculations made by both the device 200 and the rocket may be used for validation of the current trajectory and any alterations to the course that have been determined by either the device 200 or the rocket.

In some embodiments, both device 200 and the rocker may be in communication with a ground station as well as each other. This may provide additional redundancy for any communication failures during the launch. In some embodiments, separate hardware and protocols may be used for communication between the device 200 and the rocket than what is used between the device 200 or rocket and the ground station. In the event of communication loss, commands and data may be relayed through communications devices which still have a connection. For example, if communication is lost between the rocket and the ground station, the device 200 may be configured to relay messages and data from the ground station to the rocket.

FIG. 2B is a flow chart illustrating an exemplary method 240 that may be performed in accordance with some embodiments of the present disclosure. In this example, the system may determine an altitude and direction to release a payload, such as a rocket. The system may wirelessly receive commands to release the payload and/or the system may autonomously release the payload when certain positional criteria has been met, such as the gondola being positioned in a particular launch window in an altitude range and/or being within a particular geospatial position in the atmosphere.

At step 241, the system may calculate a trajectory for the rocket, wherein the trajectory comprises a direction and pitch angle. The trajectory includes the direction that the rocket may be launched and the pitch angle that the rocket would be released.

At step 242, the system may determine a launch sequence. The launch sequence may include the sequence in which the rocket propulsion systems are activated or powered.

At step 243, the system may calculate a release timing for each of two or more attachment units, wherein the release timing is calculated based at least in part on the pitch angle. For example, to achieve the desired pitch angle the rocket may be released where one attachment unit is released first and then another attachment unit is release. This allows the portion of the rocket to begin to descend while the other attached portion of the rocket remains affixed to the attachment unit. A time period is determined where the next attachment unit is released. By varying the release time of the attachments, the rocket then may be positioned at a particular angle.

At step 244, the system may orient the stratospheric gondola to point the rocket in a direction of orbit for launching the rocket and its payload. The system may use the propellers to rotate such that the gondola is rotated and maintained to the desired direction.

At step 245, the system may control each of the two or more attachment units, wherein the controlling comprises releasing each of the two or more attachment units based on the calculated release timings. For example, the rocket after being released may have a nose up attitude with a pitch angle of between 1 to 50 degrees above the Earth's horizon.

At step 246, the system may ignite thrusters of the rocket upon reaching a predetermined separation distance from the stratospheric gondola and the calculated pitch angle. The system may provide command signals to the rocket when then may cause the rocket propulsion system to activate. Alternatively, the rocket may automatically activate its propulsion system, such as at a predetermined separation distance of the gondola.

FIG. 2C is a flow chart illustrating an exemplary method 250 that may be performed in accordance with some embodiments of the present disclosure. In this example, the system may carry a payload and determine whether the gondola has reached a desired launch window, and either release and launch the payload or abort the release of the payload.

At step 251, the system may receive data from one or more sensors of a stratospheric gondola, wherein the stratospheric gondola is carrying an orbital rocket to be launched. The gondola may include various sensors to determine its geospatial position, altitude, direction, etc.

At step 252, the system may determine a position and altitude of the stratospheric gondola based at least partially on the received sensor data.

At step 253, the system may calculate a trajectory and flight path from the determined position and altitude for the orbital rocket to reach a target orbital position.

At step 254, the system may determine if the orbital rocket can reach the target orbital position based on the calculated trajectory and flight path, and abort if the determination is negative.

At step 255, the system may compare the position and altitude of the stratospheric gondola to a predetermined target launch position and altitude, and abort if outside of a predetermined threshold range.

At step 256, the system may then initiate the launch sequence for the orbital rocket.

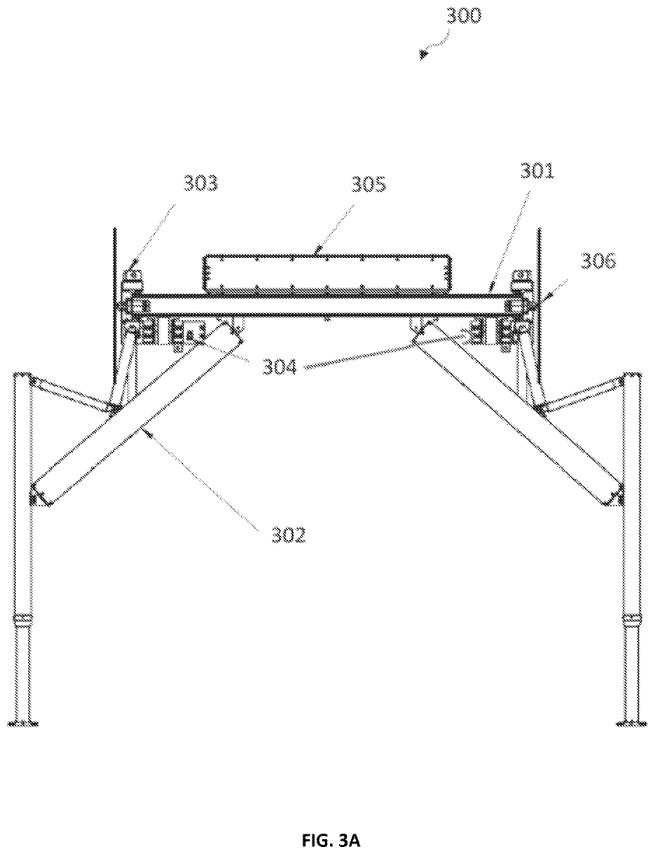

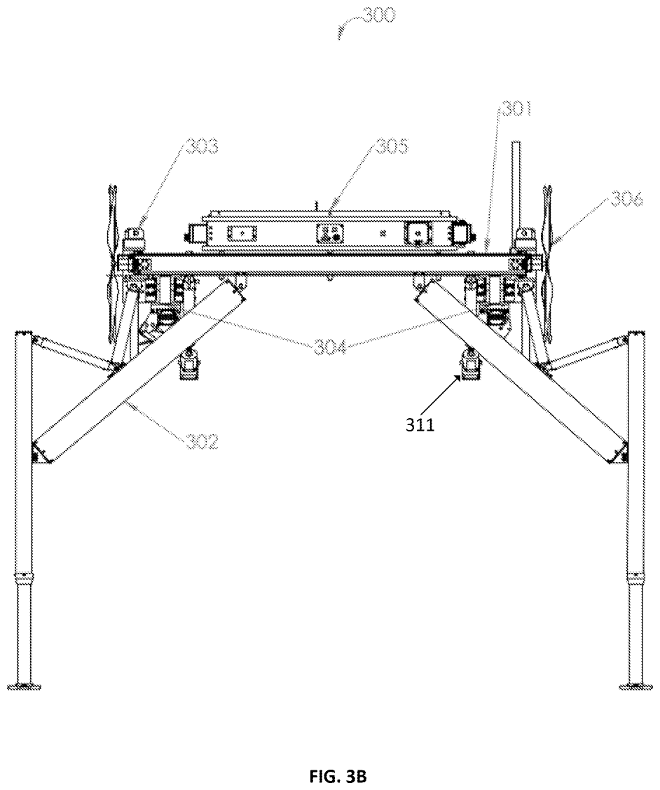

FIG. 3A illustrates an example embodiment of an active payload transportation device comprising a gondola 300 in a first position. The gondola 300 comprises a frame 301. The frame 301 provides the main carrying capacity of the gondola 300 and is configured to withstand the loads experienced at parachute deployment with a payload (rocket) attached. Landing legs 302 are attached to the frame and configured to enable the safe landing of the gondola and payload. A hoisting system is configured to connect the frame to the parachute, for example using anchor points 303, and allow free rotation of the gondola for control purposes. In an example embodiment, the hoisting system comprises a system of cables, shackles, and custom swivels, or similar components.

A launch mechanism 304 comprises a structure and mechanism configured to hold the rocket prior to launch. Avionics 305 comprise a bay attached to the frame which houses the avionics and the various electronic components that perform communications, flight status monitoring and control. Control system 306 comprises a subset of avionics which includes propellers (as described in relation to FIG. 2A), mechanical arms to support the propellers, and control system electronics and software configured to control the gondola 300. The control system may provide commands to the propellers to cause the gondola to rotate in either direction. This allows the gondola to position a payload to be released in a desired orientation or direction. For example, when the gondola reaches a desired altitude the propellers may cause the gondola to orient and maintain a desired direction prior to the release of a payload.

FIG. 4A illustrates a gondola 400, similar to the gondola 300 of FIG. 3A, in a second position with propellers in an operational position. The gondola 300 in FIG. 3A and the gondola 400 in FIG. 4A are example embodiments of the device 200 of FIG. 2A.

FIG. 3B illustrates an example embodiment of an active payload transportation device comprising a gondola 300 in a first position. The gondola 300 of FIG. 3B is similar to that of FIG. 3A, and therefore not described in detail for sake of brevity. Gondola 300 may further comprise one or more payload side supports 311.

FIG. 4B illustrates a gondola 400, similar to the gondola 300 of FIG. 3B, in a second position with propellers in an operational position. The gondola 300 in FIG. 3B and the gondola 400 in FIG. 4B are example embodiments of the device 200 of FIG. 2A. The gondola 400 of FIG. 4B is similar to that of FIG. 4A and are not described in detail for sake of brevity. Gondola 400 may also comprise one or more payload side supports as described with regard to FIG. 3B.

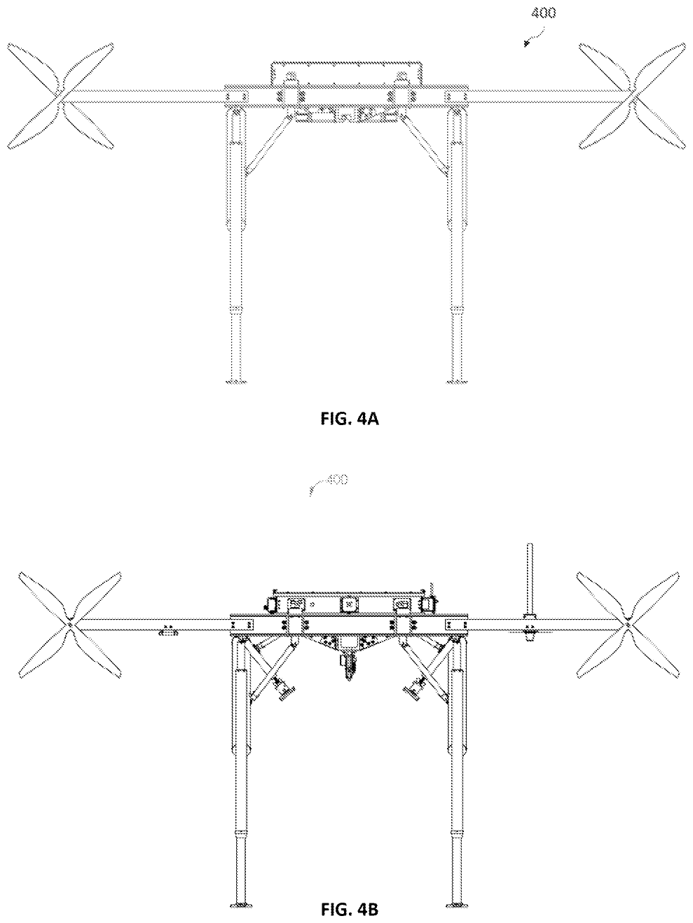

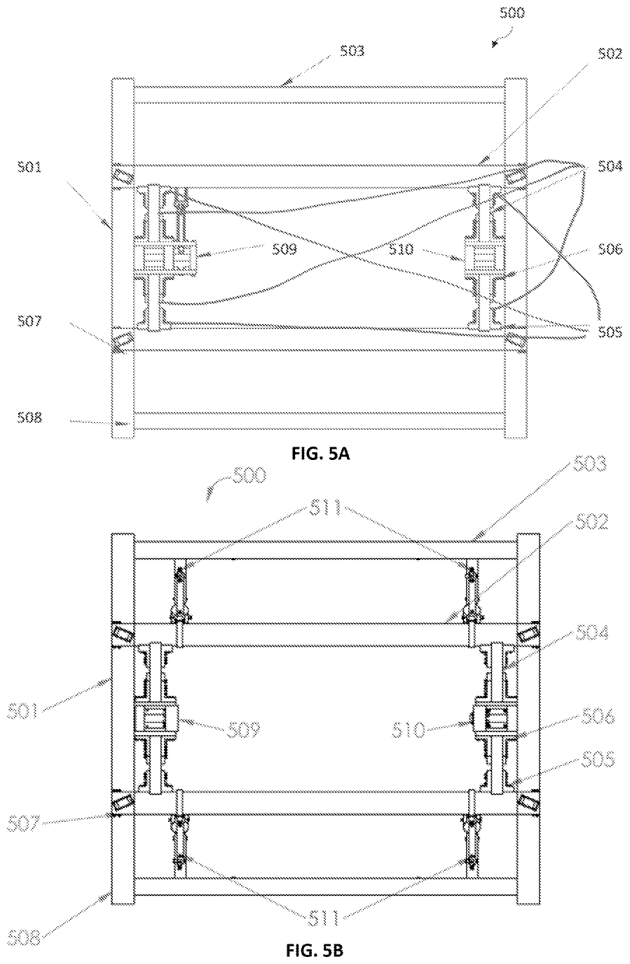

FIG. 5A illustrates details of a gondola frame 500 according to an embodiment of the present disclosure. The gondola frame 500 is similar to, and an example embodiment of, the frame 301 in FIG. 3A and the frame 210 in FIG. 2A. In an embodiment, the frame 500 is a structural hub to which everything else in the gondola connects, including: control arms to which propellers are attached; an avionics box, which sits on top of the frame; legs and rocket are connected to the frame; frame is connected to hoisting system, which is connected to the parachute. The gondola frame 500 provides for scalability for larger rockets and orbital launch.

In an example embodiment, the gondola frame 500 is the main structural element of the gondola. In an example implementation, the frame 500 is constructed of a durable material, such as aluminum, and designed to support the weight of a small orbital-class rocket under the loading conditions described in “NASA Procedures and Guidelines 820—Gondola Structural Design Requirements”. In an example embodiment, the frame 500 comprises a plurality of attachment points, for example four attachment points, for the hoisting system on the top surface. In an example embodiment, the frame 500 comprises at least one attachment point, for example two attachment points, for the rocket on the underside of the frame. In an example embodiment, the frame 500 also supports the avionics bay and propeller control arms.

While different implementations of the frame 500 are possible, the example implementation shown in FIG. 5A includes the following components: Main I-Beam 501 comprises a major structural element to which the structure connects to the hoisting system. Tube-1 502 acts to absorb torsional loads and transfer them into normal bending moments in Main I-Beam 501. Secondary I-Beam 503 comprises a minor structural element which acts to absorb loads from landing. Attachment point support beam 504 comprises a box beam which acts to transfer loads from the rocket's inertial loads to the frame. Curved bracket 505 acts as the connection between Tube-1 502 and the attachment point support beam 504. The flat bracket 506 acts as a connection between the attachment point support beam 504 and the two attachment point assemblies (509 and 510). Tube-1 connector 507 acts as the connection between Tube-1 502 and I-Beam-1 501. Secondary I-Beam bracket 508 connects Main I-Beam 501 and Secondary I-Beam 503. Attachment points, or launch mechanism components, or launch mechanism modules, 509 and 510 comprise components of the launch mechanism, similar to the launch mechanism 304 in FIG. 3A.

The components of the frame 500 as shown in FIG. 5A cooperate to enable the gondola to be able to hold a rocket and to land the gondola, possibly still with the rocket attached. In an embodiment, the gondola frame 500 is configured to hold the rocket and be able to land the rocket if it is necessary to abort the mission. When the parachute deploys, a result is a significant amount of force on the gondola, and the frame is shaped and constructed to handle this. In an example embodiment, the frame is shaped and constructed to absorb the energy of parachute deployment, which may require handling 8 times its own weight including the weight of the payload (i.e. rocket).

In some embodiments, the space between Tube-1 502 and Secondary I-Beam 503 may be used to hold additional payload. For example, additional liquid oxygen may be carried to continually fill and maintain a maximum level of liquid oxygen in a rocket until launch.

In some embodiments, additional lifting gas may be carried for adjusting altitude. In some embodiments, liquid helium may be carried in the space to cool telescopic equipment. Solar panels may also be housed within the space to reduce the need for heavy battery packs.

FIG. 5B illustrates details of a gondola frame 500 according to an embodiment of the present disclosure. The gondola frame 500 is similar to, and an example embodiment of, the frame 301 in FIG. 3B and the frame 210 in FIG. 2A. The gondola frame 500 of FIG. 5B is similar or the same to that of gondola frame 500 in FIG. 5A, with the exception of payload side supports 511. Payload side supports 511 may be detachable and configurable. In some embodiments, additional payload side supports 511 may be added at different locations based on the size and support needs of the payload.

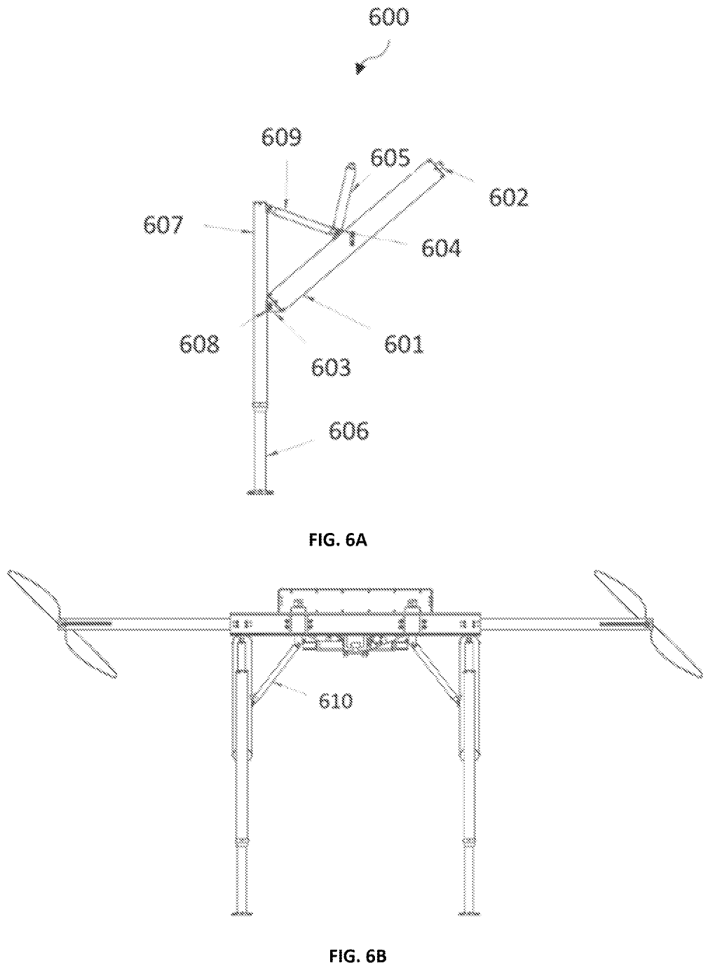

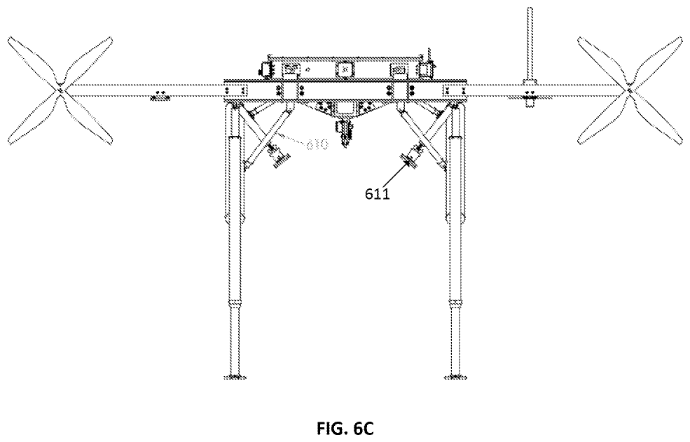

FIG. 6A and FIG. 6B illustrate details of gondola legs according to an embodiment of the present disclosure. In FIG. 6A, the gondola legs 600 are shown in isolation, while FIG. 6B shows the gondola legs in the context of the gondola. The gondola legs 600 are an example embodiment of the gondola legs 220 from FIG. 2A, and 302 from FIG. 3A, and are configured for use for takeoff and landing. In other embodiments, the gondola may not include gondola legs 600.

In an embodiment, the gondola comprises a plurality of legs. In an example embodiment, the gondola comprises at least 3 legs. In another example embodiment, the gondola comprises 4 legs. During takeoff, the legs 600 support the weight of the gondola and keep the payload (e.g. rocket) above the ground. During landing, the legs 600 absorb the energy of the gondola as it encounters the ground under parachute descent.

In an embodiment, the gondola comprises an energy absorbing material configured to absorb energy during landing, and reduce stress on the gondola. In an example embodiment, the crushable material is provided on an exterior surface of the gondola. In another example embodiment, the crushable material is provided at an impact-bearing component of the gondola, such as at one or more of the plurality of legs. In another example embodiment, the crushable material is provided in an impact-bearing component of the gondola, such as within one or more of the plurality of legs. Providing the crushable material in, or within, an impact-bearing component, such as a leg, provides increased tolerance of offset in landing. Providing the crushable material in, or within, an impact-bearing component, such as a leg, may also restrict a direction in which the material may be crushed, increasing the efficiency and effectiveness of the crushable material in absorbing energy.

In an example embodiment, at least one of a plurality of legs 600 of the gondola is a telescopic leg defining a void space in which an energy absorbing material is provided. In an example embodiment, each of the plurality of legs 600 is telescopic and comprises deformable foam provided in the vertical section of each telescopic leg. During landing, these telescopic leg devices compress the deformable foam, which in turn absorbs the energy of the landing. In an example embodiment, a crushable foam is provided inside one or more of the plurality of legs. In an example embodiment, a crushable foam is provided inside each of the plurality of legs.

In some embodiments, the plurality of legs may comprise spring damper systems, hydraulic shock absorbers and/or pneumatic shock absorbers configured to absorb energy during landing of the gondola.

In an embodiment, one or more of the legs is shaped and constructed to be moveable or removable, to facilitate transportation. In an embodiment, at least one of the plurality of legs is configured to be provided in an operational position or in a stowed position. In another embodiment, at least one of the plurality of legs is configured to be removable. In an example embodiment, each of the plurality of legs is configured to be removable for transportation. In such an embodiment, the legs are configured to separate from the main gondola frame through a series of fasteners, such as pins or screws, at the top of the legs. This allows the size of the gondola to be reduced significantly when necessary. While removability of the legs is not required for mission success, it is desirable with respect to transportation. Embodiments of the present disclosure provide a gondola that has legs configured to land in a stable form and absorb the energy.

In some embodiments, based on mission requirements, the gondola may be configured to have no legs attached.

An example embodiment, as shown in FIG. 6A and FIG. 6B, includes the following components. A main leg 601 comprises the primary load bearing part of the leg during the landing sequence. A main leg upper end cap 602 connects the main leg 601 to the frame. A main leg lower end cap 603 connects the main leg 601 to a pogo support assembly 607. A leg support connector 604 connects the main leg 601 and a leg support assembly 605. The leg support assembly 605 is shaped and constructed to provide the necessary reaction force to support the leg during landing.

A pogo piston 606 acts to transfer the load applied at the bottom to the foam and transfer the energy. A pogo support assembly 607 provides the main housing for the energy absorbing material (not shown in FIG. 6A), which is provided inside the pogo support assembly 607. The pogo piston 606 and the pogo support assembly 607 cooperate to enable the leg 600 to operate as a telescopic leg. A pogo connector 608 connects the pogo support assembly 607 to the main leg 601. In an example embodiment, the pogo connector is welded onto the pogo support assembly. A longitudinal brace 609 is shaped and constructed to deal with some of the transverse loads occurring along the x-axis of the frame that may be anticipated during landing. A side brace 610, as shown in FIG. 6B, is shaped and constructed to deal with some of the transverse loads occurring along the y-axis of the frame that may be anticipated during landing.

In an example embodiment, a gondola is provided with 4 legs, with each leg connected to the frame from 3 locations. In this example embodiment, inside each leg a crushable foam is provided, such that the base acts like a piston, crushing the foam upon landing. In this example embodiment, each of the legs is connected with 3 pins to the frame, facilitating detachment of the legs, which is important for transportability, since the gondola doesn't conveniently fit in standard vehicles for transportation, unless you can disassemble. In this example embodiment, the legs are the first point of contact with the ground; when the legs engage, crushable foams are crushed to absorb energy.

FIG. 6C illustrates details of gondola legs according to an embodiment of the present disclosure. In FIG. 6C, the gondola legs are shown in the context of the gondola. Payload side supports 611 may be configured to provide extra support and stability to payloads loaded onto the gondola.

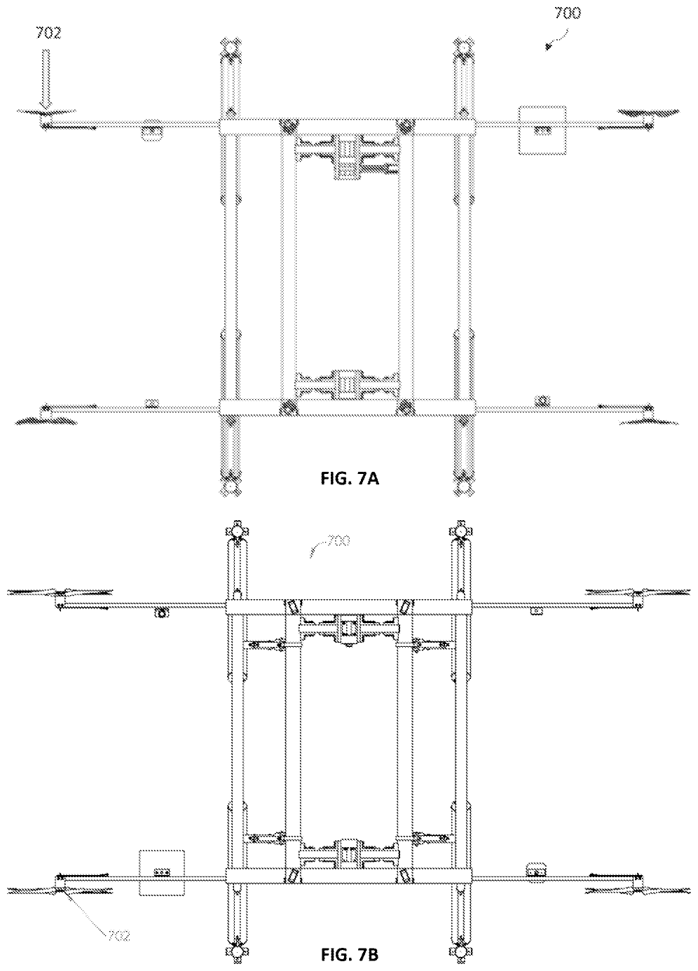

FIG. 7A illustrates details of a gondola control system 700 according to an embodiment of the present disclosure. In an embodiment, the control system 700 is configured to orient the gondola. As the gondola is landing and descending, the control system 700 is activated to orient the gondola with the direction of motion of the gondola, because the direction of motion is dictated by the wind, which is out of the control of the gondola operator. In an embodiment, the control system 700 orients the gondola to match the direction of motion dictated by the wind. Also, in an embodiment in which the gondola is asymmetric, the control system 700 controls the gondola and enables the gondola to land such that the gondola does not tip over. When the gondola lands, the legs engage, the energy absorbing material is crushed and absorbs the energy, keeping the gondola and all elements carried by the gondola safe from harm.

In an embodiment, the control system 700 is configured to point the payload (e.g., a rocket) in a commanded direction. In an example embodiment, the control system 700 has a plurality of thrusters, shown as a total of 4 thrusters 702, for example 4 propellers as shown in FIG. 7A. In an example embodiment, the 4 propellers comprise 2 redundant propellers in each direction of rotation, for example 2 propellers for clockwise rotation and 2 propellers for counterclockwise rotation. The propeller-based control system 700 according to the example embodiment in FIG. 7A provides advantages of being more mass effective and providing quicker response than other thrusters. In other implementations when such advantages are not critical, the thrusters comprise any type of thruster, such as cold gas thrusters or electric thrusters.

The control system 700 is configured to continue operation if one propeller 702 stops functioning in each direction of rotation. In the example embodiment of FIG. 7A with 4 propellers, the normal nominal condition is to have two diagonally opposite propellers 702 operating together to move in one direction. However, if any one propeller is out in any given direction, the system still enables control in that direction by using one of the redundant propellers 702, or one of the pair of diagonally opposite propellers. In an example embodiment, the control system 700 comprises a double redundant system, where 2 failures are needed to fail the system. In another example embodiment, the control system 700 comprises 6 propellers 702, with 3 propellers configured to rotate in one direction, and 3 propellers configured to rotate in the other direction. In an embodiment, the control system 700 comprises a redundant control system including at least 4 propellers, where the at least 4 propellers are configured to provide redundancy and have control in both directions. In an alternative embodiment, the control system 700 comprises at least 2 propellers, with one propeller for each direction.

In an example embodiment where the thrusters comprise propellers, the operating conditions of the control system 700 range between sea level and 35 km above mean sea level. In an example embodiment where the thrusters comprise cold gas thrusters, the operating conditions are extended to higher altitudes. In an example embodiment, the system is configured to withstand gusts of wind while performing controls at all altitudes. In an example embodiment, the flight controller is run on the flight computers and is calibrated to perform under varying atmospheric conditions.

In an example implementation, the control system 700 is primarily used to spin the gondola. In an example embodiment with 4 arms and 4 propellers, in order to spin the gondola, diagonal motors are engaged to enable the rotation. In an embodiment, the control system 700 is a subset of the avionics system. In an example implementation, the avionics system is provided on top of the frame, for example on top of circular beams at a top of the frame. The avionics system has other functions, and is responsible for power management, thermal management, and also for navigation (used to determine what orientation the rocket should be pointed at). With respect to power management, the avionics system provides and manages power to all of the electronics on the gondola. With respect to thermal management, the avionics system is configured, in an example implementation, to ensure that when the gondola is at a 30 km altitude and the environmental temperature is −50 degrees Celsius, the batteries are not going to freeze. The avionics system is also configured to coordinate communications with the ground, to release the rocket at the right time. The avionics system may also be configured to provide information about all systems of the gondola, for example temperature of various components and voltage of battery or orientation of the gondola.

FIG. 7B illustrates details of a gondola control system 700 according to an embodiment of the present disclosure. FIG. 7B is similar to that of FIG. 7A and not described in detail for sake of brevity. FIG. 7B shows an embodiment in which payload side supports are included in the frame to provide extra support to large payloads.

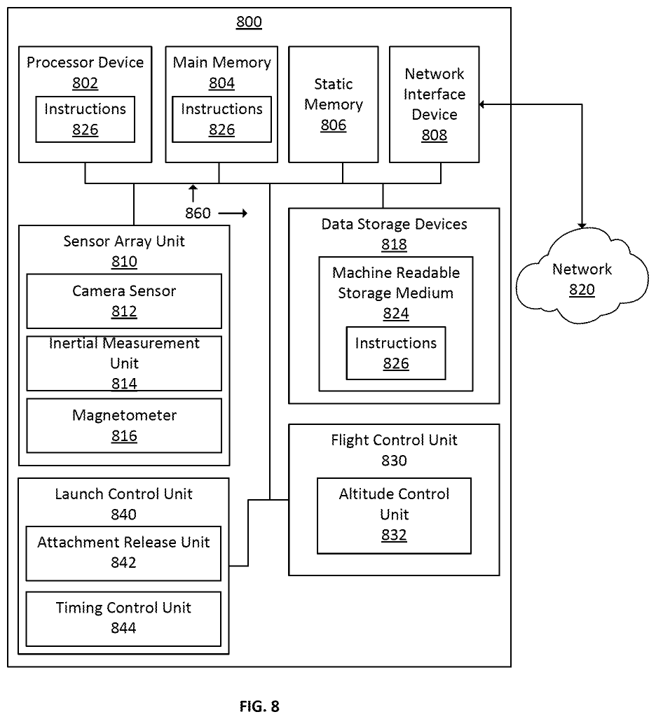

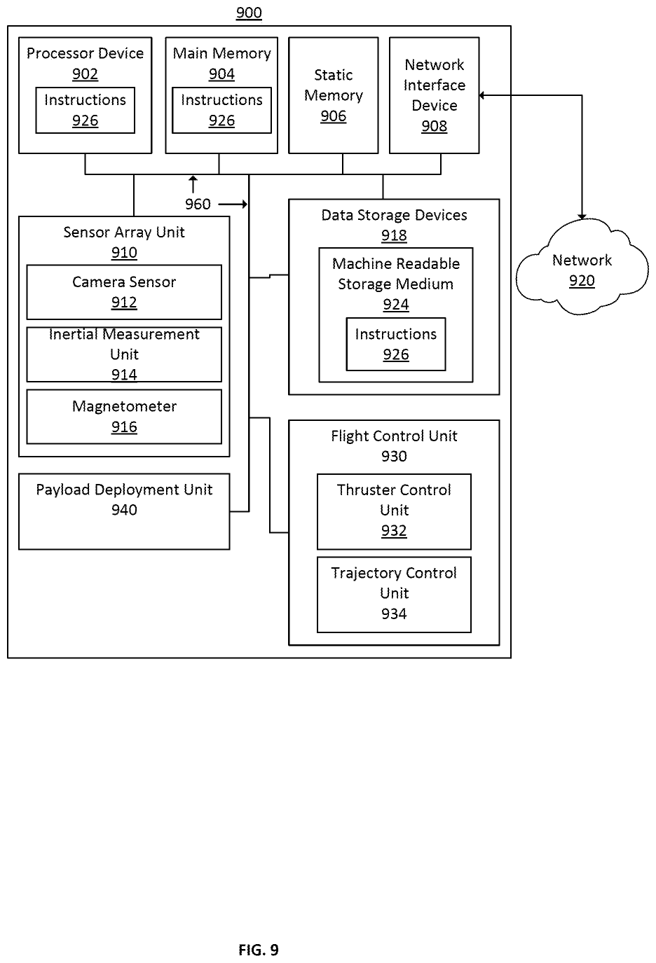

FIG. 8 illustrates an example machine of a stratospheric gondola and its associated computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 800 includes a processor device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 818, which communicate with each other via a bus 860.

Processor device 802 represents one or more general-purpose processing devices such as a microprocessor, a central processing unit, or the like. More particularly, the processor set computing (RISC) microprocessor, very long instruction word (VLIW) microprocessor, or processor implementing other instruction sets, or processors implementing a combination of instruction sets. Processor device 802 may also be one or more special-purpose processing devices such as an application specific integrated circuit (ASIC), a field programmable gate array (FPGA), a digital signal processor (DSP), network processor, or the like. The processor device 802 is configured to execute instructions 826 for performing the operations and steps discussed herein.

The computer system 800 may further include a network interface device 808 to communicate over the network 820. Network interface device 808 may comprise one or more receiver units, transmitter units, transceiver units or other communication units configured to communicate wirelessly. In some embodiments, the network interface device 808 may comprise units for LTE, GSM, HSPA+, Sub 1 GHz, Bluetooth, Bluetooth low energy, LORAWAN, LPWAN or WIFI (802.11abgn or other WIFI standards) communication and their associated hardware and software. Other communications standards and protocols and their respective communication units (hardware and software) may be used as well, either by themselves or in combination with each other and those listed above. In some embodiments, multiple communication units may be used, either concurrently/in parallel or at separate times.

The computer system 800 also may include sensor array 810. Sensor array 810 may comprise a camera sensor 812, inertial measurement unit 814 and magnetometer 816.

The data storage device 818 may include a machine-readable storage medium 824 (also known as a computer-readable medium) on which is stored one or more sets of instructions or software 826 embodying any one or more of the methodologies or functions described herein. The instructions 826 may also reside, completely or at least partially, within the main memory 804 and/or within the processor device 802 during execution thereof by the computer system 800, the main memory 804 and the processor device 802 also constituting machine-readable storage media.

In one implementation, the instructions 826 include instructions to implement functionality corresponding to the components of a device to perform the disclosure herein. While the machine-readable storage medium 824 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

The computer system 800 also may include flight control unit 830 and launch control unit 840. Flight control unit 830 may further comprise altitude control unit 832. Altitude control unit 832 may control the release of lifting gas from a balloon valve. Flight control unit 830 may also control a plurality of propellers or thrusters configured to rotate the gondola.

Launch control unit 840 may further comprise attachment release unit 842 and timing control unit 844. The launch sequence of the rocket may be controlled by the launch control unit, wherein the timing control unit may instruct the attachment release unit to release one or more attached hooks at specified times to position the rocket in a desired trajectory and pitch before igniting the rocket thrusters.

FIG. 9 illustrates an example machine of an orbital rocket and its associated computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processor device 902, a main memory 904 (e.g., read-only memory (ROM), flash memory, dynamic random access memory (DRAM) such as synchronous DRAM (SDRAM) or Rambus DRAM (RDRAM), etc.), a static memory 906 (e.g., flash memory, static random access memory (SRAM), etc.), and a data storage device 918, which communicate with each other via a bus 960.

Processor device 902 represents one or more general-purpose processing devices such as a microprocessor, a central processing unit, or the like. More particularly, the processor set computing (RISC) microprocessor, very long instruction word (VLIW) microprocessor, or processor implementing other instruction sets, or processors implementing a combination of instruction sets. Processor device 902 may also be one or more special-purpose processing devices such as an application specific integrated circuit (ASIC), a field programmable gate array (FPGA), a digital signal processor (DSP), network processor, or the like. The processor device 902 is configured to execute instructions 926 for performing the operations and steps discussed herein.

The computer system 900 may further include a network interface device 908 to communicate over the network 920. Network interface device 908 may comprise one or more receiver units, transmitter units, transceiver units or other communication units configured to communicate wirelessly. In some embodiments, the network interface device 808 may comprise units for LTE, GSM, HSPA+, Sub 1 GHz, Bluetooth, Bluetooth low energy, LORAWAN, LPWAN or WIFI (802.11abgn or other WIFI standards) communication and their associated hardware and software. Other communications standards and protocols and their respective communication units (hardware and software) may be used as well, either by themselves or in combination with each other and those listed above. In some embodiments, multiple communication units may be used, either concurrently/in parallel or at separate times.

The computer system 900 also may include sensor array 910. Sensor array 910 may comprise a camera sensor 912, inertial measurement unit 814 and magnetometer 916.

The data storage device 918 may include a machine-readable storage medium 924 (also known as a computer-readable medium) on which is stored one or more sets of instructions or software 926 embodying any one or more of the methodologies or functions described herein. The instructions 926 may also reside, completely or at least partially, within the main memory 904 and/or within the processor device 902 during execution thereof by the computer system 900, the main memory 904 and the processor device 902 also constituting machine-readable storage media.

In one implementation, the instructions 926 include instructions to implement functionality corresponding to the components of a device to perform the disclosure herein. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

The computer system 900 also may include flight control unit 930 and payload deployment unit 940. Flight control unit 930 may further comprise thruster control unit 932 and trajectory control unit 934. The payload deployment unit 940 may control the deployment of the orbital rocket's payload.

It will be appreciated that the present disclosure may include any one and up to all of the following examples.

Example 1: A stratospheric gondola configured to carry and deploy a payload in in a high altitude atmosphere, the gondola comprising: a frame configured to carry a payload, the payload comprising a rocket and a payload of the rocket; a plurality of legs connected to the frame; and a control system connected to the frame, the control system comprising: a plurality of propellers; one or more sensors; two or more attachment units, wherein the attachment units are releasably attached to the rocket by one or more hooks; and one or more launch control units; wherein the control system is configured to: calculate a trajectory for the rocket, wherein the trajectory comprises a direction (i.e. heading) and pitch angle; determine a launch sequence, wherein the launch sequence comprises calculating a release timing of each of the two or more attachment units; wherein the release timing is calculated based at least in part on the pitch angle; orient the stratospheric gondola to point the rocket in a direction of orbit for launching the rocket and its payload, wherein the orienting comprises engaging one or more of the plurality of propellers; and control, by the one or more launch control units, each of the two or more attachment units, wherein the controlling comprises releasing each of the two or more attachment units based on the calculated release timings.

Example 2: The gondola of Example 1, wherein the plurality of propellers comprises a first primary propeller configured to move the gondola in a first direction, and a second primary propeller configured to move the gondola in a second direction opposite to the first direction.

Example 3: The gondola of any one of Examples 1-2, wherein the plurality of propellers comprises a first redundant propeller configured to move the gondola in the first direction, and a second redundant propeller configured to move the gondola in the second direction.

Example 4: The gondola of any one of Examples 1-3, wherein one or more of the legs is configured to be provided in an operational position or in a stowed position.

Example 5: The gondola of any one of Examples 1-4, wherein one or more of the legs is configured to be removable.

Example 6: The gondola of any one of Examples 1-5, wherein at least one of the plurality of legs is configured to be collapsible.

Example 7: The gondola of any one of Examples 1-6, wherein each of the plurality of legs is configured to be removable for transportation.

Example 8: The gondola of any one of Examples 1-7, wherein the removable legs are configured to separate from the main gondola frame through a series of shear pins or screws.

Example 9: The gondola of any one of Examples 1-8, wherein the plurality of legs comprises at least 3 legs.

Example 10: The gondola of any one of Examples 1-9, wherein the plurality of legs comprises 4 legs.

Example 11: The gondola of any one of Examples 1-10, further comprising an energy absorbing material configured to absorb energy during landing, and reduce stress on the gondola.

Example 12: The gondola of any one of Examples 1-11, wherein the energy absorbing material comprises a crushable material provided in an impact-bearing component of the gondola.

Example 13: The gondola of any one of Examples 1-12, wherein the energy absorbing material is provided at one or more of the plurality of legs.

Example 14: The gondola of any one of Examples 1-13, wherein at least one of the plurality of legs comprises a telescopic leg, and wherein the energy absorbing material is provided within the telescopic leg.

Example 15: The gondola of any one of Examples 1-14, wherein each the plurality of legs comprises a telescopic leg, and wherein the energy absorbing material is provided within each of the telescopic legs.

Example 16: An active payload transportation device configured to carry and launch an active payload in high altitude atmosphere, comprising: a frame configured to carry the active payload; a plurality of legs connected to the frame; and a control system connected to the frame, the control system comprising: a plurality of propellers; one or more sensors; two or more attachment units, wherein the attachment units are releasably attached to the active payload by one or more hooks; and one or more launch control units; wherein the control system is configured to: calculate a trajectory for the active payload, wherein the trajectory comprises a direction and pitch angle; determine a launch sequence, wherein the launch sequence comprises calculating a release timing of each of the two or more attachment units; wherein the release timing is calculated based at least in part on the pitch angle; orient the active payload transportation device to point the active payload in a desired direction for deploying the active payload, wherein the orienting comprises engaging one or more of the plurality of propellers; and control, by the one or more launch control units, each of the two or more attachment units, wherein the controlling comprises releasing each of the two or more attachment units based on the calculated release timings.

Example 17: A payload transportation device configured to carry and orient an operable payload in high altitude atmospheric, comprising: a frame configured to carry the operable payload; a plurality of legs connected to the frame; and a control system connected to the frame, the control system comprising: a plurality of propellers; one or more sensors; two or more attachment units, wherein the attachment units are releasably attached to the operable payload by one or more hooks; and one or more payload orientation control units; wherein the payload orientation control units are configured to: calculate a target orientation of the operable payload, wherein the orientation comprises a direction and pitch angle; determine one or more adjustments to be made to a current orientation of the operable payload; and orient the operable payload according to the determined one or more adjustments.

Example 18: The payload transportation device of Example 17, wherein the operable payload comprises a scientific payload.

Example 19: The payload transportation device of any one of Examples 17-19, wherein the scientific payload comprises a telescope, camera system, weather monitoring system, other high altitude monitoring device, or a combination thereof.

Example 20: The payload transportation device of any one of Examples 17-19, wherein one or more of the plurality of legs further comprises a spring dampening unit configured to absorb energy during landing, and reduce stress on the gondola.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

In the preceding description, for purposes of explanation, numerous details are set forth in order to provide a thorough understanding of the embodiments. However, it will be apparent to one skilled in the art that these specific details are not required. In other instances, well-known mechanical structures, electrical structures and circuits are shown in generalized or block diagram form in order not to obscure the understanding. For example, specific details are not provided as to whether the embodiments described herein are implemented as a software routine, hardware circuit, firmware, or a combination thereof.

The embodiments described herein are intended to be examples only. Alterations, modifications and variations can be effected to the particular embodiments by those of skill in the art. The scope of the claims should not be limited by the particular embodiments set forth herein, but should be construed in a manner consistent with the specification as a whole.

All publications, patents and patent applications mentioned in this Specification are indicative of the level of skill those skilled in the art to which this invention pertains and are herein incorporated by reference to the same extent as if each individual publication patent, or patent application was specifically and individually indicated to be incorporated by reference.

The invention being thus described, it will be obvious that the same may be varied in many ways. Such variations are not to be regarded as a departure from the spirit and scope of the invention, and all such modification as would be obvious to one skilled in the art are intended to be included within the scope of the following claims.

What is claimed is:

1. A stratospheric gondola configured to carry and deploy a payload in high altitude atmosphere, comprising:
a frame configured to carry the payload, wherein the payload comprises a rocket and a payload of the rocket;
a plurality of legs connected to the frame; and
a control system connected to the frame, the control system comprising:
a plurality of propellers;
one or more sensors;
two or more attachment units, wherein the attachment units are releasably attached to the rocket by one or more hooks; and
one or more launch control units;
wherein the control system is configured to:
calculate a trajectory for the rocket, wherein the trajectory comprises a direction and pitch angle;
determine a launch sequence, wherein the launch sequence comprises calculating a release timing of each of the two or more attachment units;
wherein the release timing is calculated based at least in part on the pitch angle;
orient the stratospheric gondola to point the rocket in a direction of orbit for launching the rocket and its payload, wherein the orienting comprises engaging one or more of the plurality of propellers; and
control, by the one or more launch control units, each of the two or more attachment units, wherein the controlling comprises releasing each of the two or more attachment units based on the calculated release timings.

2. The gondola of claim 1 wherein the plurality of propellers comprises a first primary propeller configured to move the gondola in a first direction, and a second primary propeller configured to move the gondola in a second direction opposite to the first direction.

3. The gondola of claim 2 wherein the plurality of propellers comprises a first redundant propeller configured to move the gondola in the first direction, and a second redundant propeller configured to move the gondola in the second direction.

4. The gondola of claim 1 wherein one or more of the legs is configured to be provided in an operational position or in a stowed position.

5. The gondola of claim 1 wherein one or more of the legs is configured to be removable.

6. The gondola of claim 1 wherein at least one of the plurality of legs is configured to be collapsible.

7. The gondola of claim 1 wherein each of the plurality of legs is configured to be removable for transportation.

8. The gondola of claim 7 wherein the removable legs are configured to separate from the main gondola frame through a series of shear pins or screws.

9. The gondola of claim 1 wherein the plurality of legs comprises at least 3 legs.

10. The gondola of claim 1 wherein the plurality of legs comprises 4 legs.

11. The gondola of claim 1 further comprising an energy absorbing material configured to absorb energy during landing, and reduce stress on the gondola.

12. The gondola of claim 11 wherein the energy absorbing material comprises a crushable material provided in an impact-bearing component of the gondola.

13. The gondola of claim 11 wherein the energy absorbing material is provided at one or more of the plurality of legs.

14. The gondola of claim 11 wherein at least one of the plurality of legs comprises a telescopic leg, and wherein the energy absorbing material is provided within the telescopic leg.

15. The gondola of claim 11 wherein each the plurality of legs comprises a telescopic leg, and wherein the energy absorbing material is provided within each of the telescopic legs.

16. An active payload transportation device configured to carry and launch an active payload in high altitude atmosphere, comprising:
a frame configured to carry the active payload;
a plurality of legs connected to the frame; and
a control system connected to the frame, the control system comprising:
a plurality of propellers;
one or more sensors;
two or more attachment units, wherein the attachment units are releasably attached to the active payload by one or more hooks; and
one or more launch control units;
wherein the control system is configured to:
calculate a trajectory for the active payload, wherein the trajectory comprises a direction and pitch angle;
determine a launch sequence, wherein the launch sequence comprises calculating a release timing of each of the two or more attachment units;
wherein the release timing is calculated based at least in part on the pitch angle;
orient the active payload transportation device to point the active payload in a desired direction for deploying the active payload, wherein the orienting comprises engaging one or more of the plurality of propellers; and
control, by the one or more launch control units, each of the two or more attachment units, wherein the controlling comprises releasing each of the two or more attachment units based on the calculated release timings.

17. A payload transportation device configured to carry and orient an operable payload in high altitude atmosphere, comprising:
a frame configured to carry the operable payload;
a plurality of legs connected to the frame; and
a control system connected to the frame, the control system comprising:
a plurality of propellers;
one or more sensors;
two or more attachment units, wherein the attachment units are releasably attached to the operable payload by one or more hooks; and
one or more payload orientation control units;
wherein the payload orientation control units are configured to:
calculate a target orientation of the operable payload, wherein the orientation comprises a direction and pitch angle;
determine one or more adjustments to be made to a current orientation of the operable payload; and
orient the operable payload according to the determined one or more adjustments.

18. The payload transportation device of claim 17 wherein the operable payload comprises a scientific payload.

19. The payload transportation device of claim 18 wherein the scientific payload comprises a telescope.

20. The payload transportation device of claim 17 wherein one or more of the plurality of legs further comprises a spring dampening unit configured to absorb energy during landing, and reduce stress on the gondola.
